(19) United States
(12) Patent Application Publication
(10) Pub. No.: US 2015/0081644 A1
(43) Pub. Date: Mar. 19, 2015

(54) METHOD AND SYSTEM FOR BACKING UP AND RESTORING A VIRTUAL FILE SYSTEM

(71) Applicant: OpenPeak Inc., Boca Raton, FL (US)

(72) Inventor: Michael Alan Pitts, Lake Worth, FL (US)

(21) Appl. No.: 14/333,248

(22) Filed: Jul. 16, 2014

Related U.S. Application Data
(60) Provisional application No. 61/846,736, filed on Jul. 16, 2013.

(51) Int. Cl. G06F 11/14

(52) U.S. Cl. CPC G06F 11/1469
USPC 707/676

(57) ABSTRACT

A method and system for backing up and restoring a virtual file system are described herein. In an environment in which multiple unrelated applications exchange data through a paste memory element through the use of the virtual file system, a master application from the multiple unrelated applications can be used, and the master application may be solely responsible for backing up the virtual file system. When the master application is deactivated, a snapshot of the virtual file system can be generated. The snapshot of the virtual file system can be stored in a memory location that is associated with the master application. When the master application is launched, it can be determined whether the virtual file system is inoperable. If so, the snapshot of the virtual file system can be retrieved from the memory location, and the virtual file system can be re-established based on the retrieved snapshot. Arrangements may also be made to enable any one of the unrelated applications for perform the back-up and restoration process, thereby obviating the need for a master application designation.

### CROSS-REFERENCE TO RELATED APPLICATIONS

This patent application claims priority to U.S. provisional patent application No. 61/846,736, filed on Jul. 16, 2013, which is incorporated herein by reference in its entirety.

### FIELD OF TECHNOLOGY

The present description relates to systems and methods for back-up and restoration of certain configurations and more particularly, for back-up and restoration of a virtual file system (VFS) that enables applications to exchange data.

### BACKGROUND

Many mobile communication devices have the ability to download and install applications, or apps, to increase their usefulness. Most of the apps that are installed on these devices are available at electronic storefronts known colloquially as app stores. To foster the sale of mobile communication devices and apps, the operators of the app stores have made it easy for app developers to upload their apps to the app stores. As such, there are a tremendous number of apps available from a litany of app developers at these app stores.

Because the apps may come from so many different sources, the security of the mobile devices, as well as the apps themselves, is an important issue. As such, precautions must be taken to safeguard against apps that contain malware or other malicious code. For example, apps that are installed on a mobile device may be “sandboxed,” a condition in which communications between apps is restricted. Even so, some communications between apps in this arrangement may be permitted. For example, a URL in one app may enable a user to link to another app, and the operating system may allow copy-and-paste operations between the apps. These minor data exchanges, however, are not performed in a secure manner. Thus, a need exists to enable apps to communicate securely with one another without jeopardizing or disabling the safeguards that are already in place for their protection.

### SUMMARY

A method for restoring a virtual file system is described herein. In an environment in which multiple unrelated applications exchange data through a paste memory element, a first application from the multiple unrelated applications can be activated, and the first application can be configured to retrieve the virtual file system from the paste memory element and to use the virtual file system to access data associated with the first application. The method can also include the steps of determining that the virtual file system is inoperable, retrieving a first snapshot of the virtual file system and re-establishing the virtual file system based on the retrieved snapshot.

As an example, the steps of determining that the virtual file system is inoperable, retrieving the first snapshot of the virtual file system and re-establishing the virtual file system based on the retrieved first snapshot may be performed via the first application. In another embodiment, a second application from the multiple unrelated applications can be activated in which the second application may be configured to retrieve the virtual file system from the paste memory element and to use the virtual file system to access data associated with the second application. Via the second application, it can be determined that the virtual file system is inoperable, and a second snapshot of the virtual file system can be retrieved. In addition, the virtual file system can be re-established based on the retrieved second snapshot.

In one example, retrieving the first snapshot of the virtual file system can include retrieving the first snapshot of the virtual file system from a memory element associated with the first application. Moreover, retrieving the second snapshot of the virtual file system can include retrieving the second snapshot of the virtual file system from a memory element associated with the second application. In addition, the unrelated applications can be secure applications.

Another method for restoring a virtual file system is described herein. In particular, in an environment in which multiple unrelated applications exchange data through a paste memory element through the use of the virtual file system, a master application of the multiple unrelated applications can be used in which the master application may be solely responsible for backing up the virtual file system. When the master application is deactivated, a snapshot of the virtual file system can be generated, and the snapshot of the virtual file system can be stored in a memory location that is associated with the master application. The method can also include the steps of determining whether the virtual file system is inoperable, and if it is determined that the virtual file system is inoperable, retrieving the snapshot of the virtual file system from the memory location. The virtual file system can be re-established based on the retrieved snapshot. As an example, the master application may be solely responsible for re-establishing the virtual file system based on the retrieved snapshot.

The method can also include the steps of launching a non-master application that is part of the multiple unrelated applications in which the master application is currently deactivated. Based on the launching of the non-master application, it can be determined that the virtual file system is inoperable, and if it is determined that the virtual file system is inoperable, the master application can be automatically launched to retrieve the snapshot of the virtual file system from the memory location that is associated with the master application. In one example, the multiple unrelated applications may be secure applications, and the master application can be a personal information manager application.

A computing device for backing up a virtual file system is also described herein. The device can include a paste memory element in which the paste memory element can be configured to store a virtual file system. The virtual file system can enable a first application to access data associated with the first application. The computing device can also include a memory element associated with the first application in which the first application is part of a set of multiple unrelated applications. The computing device may also be equipped with a restoration engine that can be configured to operate through the first application to generate a first snapshot of the virtual file system when the first application is deactivated and transfer the first snapshot to the memory element associated with the first application. This combination (restoration engine and first application) may also be configured to determine whether the virtual file system is inoperable when the first application is launched and if the virtual file system is inoperable, retrieve the first snapshot of the virtual file system from the memory element associated with the first application to enable the virtual file system to be restored.

In one arrangement, the paste memory element may be configured to enable the first application to share the virtual file system with any of the other unrelated applications. The computing device can also have a second memory element associated with a second application, and the virtual file system can enable the second application of the set of unrelated applications to access data associated with the second application from the second memory element.

In another arrangement, the restoration engine can be further configured to operate through the second application to generate a second snapshot of the virtual file system when the second application is deactivated, transfer the second snapshot to the memory element associated with the second application and determine whether the virtual file system is inoperable when the second application is launched. If the virtual file system is inoperable, the second snapshot of the virtual file system can be retrieved from the memory element associated with the second application to enable the virtual file system to be restored. The restoration engine can be further configured to operate through any of the unrelated applications to generate snapshots of the virtual file system and retrieve such snapshots to enable the virtual file system to be restored by any of the unrelated applications. In one example, the set of unrelated applications may be secure applications.

A computing device for backing up a virtual file system is described herein. The computing device can include a paste memory element in which the paste memory element can be configured to store a virtual file system that is configured to enable multiple unrelated applications to access their corresponding data. The device can also include a memory element associated with a master application in which the master application is part of the multiple unrelated applications and is solely responsible among the unrelated applications for backing up the virtual file system. The computing device may also include a restoration engine that may be configured to operate through the master application to generate a snapshot of the virtual file system when the master application is deactivated, transfer the snapshot to the memory element associated with the master application and determine whether the virtual file system is inoperable when the master application is launched. If the virtual file system is inoperable, the snapshot of the virtual file system can be retrieved from the memory element to enable the virtual file system to be restored.

As an example, the unrelated applications can be secure applications, and the master application can be a personal information manager application. Additionally, the master application may also be solely responsible for retrieving the snapshot of the virtual file system if it is determined that the virtual file system is inoperable.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system that is capable of supporting communications among unrelated applications.

FIG. 2 illustrates an exemplary representation of a securitization process.

FIG. 3 illustrates an exemplary environment in which multiple unrelated applications share a VFS stored in a paste memory element.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described. The term “among,” as it is used throughout this description, should not necessarily be interpreted as requiring data exchanges among three or more unrelated applications, irrespective of grammar rules.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected (directly or indirectly through other components) such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The terms “computer program medium” and “computer readable medium” are defined as one or more components that are configured to store instructions that are to be executed by a processing unit.

An “application” is defined as a program or programs that perform one or more particular tasks on a computing device. Examples of an application include programs that may present a user interface for interaction with a user or that may run in the background of an operating environment that may not present a user interface while in the background. The term “operating system” is defined as a collection of software components that directs a computing device's operations, including controlling and scheduling the execution of other programs and managing storage, input/output and communication resources. A “processing unit” is defined as one or more components that execute sets of instructions, and the components may be disparate parts or part of a whole unit and may not necessarily be located in the same physical location. The term “memory” or “memory element” is defined as one or more components that are configured to store data, either on a temporary or persistent basis. A “paste memory element” is defined as a memory element that is configured to receive data from a first application or first component (directly or indirectly) for possible eventual retrieval by that first application, first component or a second application or second component. An “interface” is defined as a component or a group of components that enable(s) a device to communicate with one or more different devices, whether through hard-wired connections, wireless connections or a combination of both. A “transceiver” is defined as a component or a group of components that transmit signals, receive signals or transmit and receive signals, whether wirelessly or through a hard-wired connection or both.

The term “unrelated applications” is defined as two or more applications that have no special permissions for sharing or managing data between (or among) them or are otherwise restricted from sharing or exchanging data in an unfettered or substantially unfettered and secure manner, either based on their construction or the environment in which they are installed (or both). For example, unrelated applications may be two or more applications that run as separate processes within an operating system. The term “file system” is defined as an abstraction that is used to organize, store and retrieve data. The term “secure application” is defined as an application that has been modified from its original form to restrict communications between the application and unauthorized programs, applications or devices and to restrict operation of the application based on policy or to alter, augment or add features associated with the operation of the application (or any combination thereof). The term “encryption engine” is defined as a component or a group of components that encrypt data, decrypt data or encrypt and decrypt data.

A “virtual file system” is a file system and accompanying data that one or more applications may access such that when one of the applications is active, that application may access the file system (and accompanying data) and when that application is deactivated, remove that access to the file system (and accompanying data) so that another application that becomes active may access the file system (and accompanying data). A “snapshot” is defined as a profile of a memory element and its accompanying file system and accompanying data captured at a particular time and configured for storage. To the extent that there are any inconsistencies between defined terms or phrases in this application and any others that may be incorporated by reference from another application, the definitions presented herein take precedence.

As explained earlier, because of security issues, applications that are installed on a mobile device are generally restricted from communicating with one another and any allowed exchanges are not performed in a secure manner. To overcome this issue, a VFS in combination with a paste memory element may be employed to enable such application to access their data and to exchange data with other applications.

A method and system for backing up and restoring such a VFS are also presented herein. In an environment in which multiple unrelated applications exchange data through a paste memory element through the use of the VFS, a master application from the multiple unrelated applications can be used, and the master application may be solely responsible for backing up the virtual file system. When the master application is deactivated, a snapshot of the VFS can be generated. The snapshot of the VFS can be stored in a memory location that is associated with the master application. When the master application is launched, it can be determined whether the VFS is inoperable. If so, the snapshot of the VFS can be retrieved from the memory location, and the VFS can be re-established based on the retrieved snapshot. Moreover, in another arrangement, any of the unrelated applications can be used to back up and restore the VFS in accordance with the procedure described here, which may obviate the need for a master application.

In either case, the VFS may be restored in the event of corruption or an unintended removal, which can ensure that the use of the VFS by the applications can remain in place. If a master application is designated to be solely responsible for the back-up and restoration of the VFS, the problem of competing versions of the VFS from other applications can be avoided. In cases where a master application is not employed, the diversity of the system can be increased because any of the unrelated applications may execute the back-up and restoration procedures.

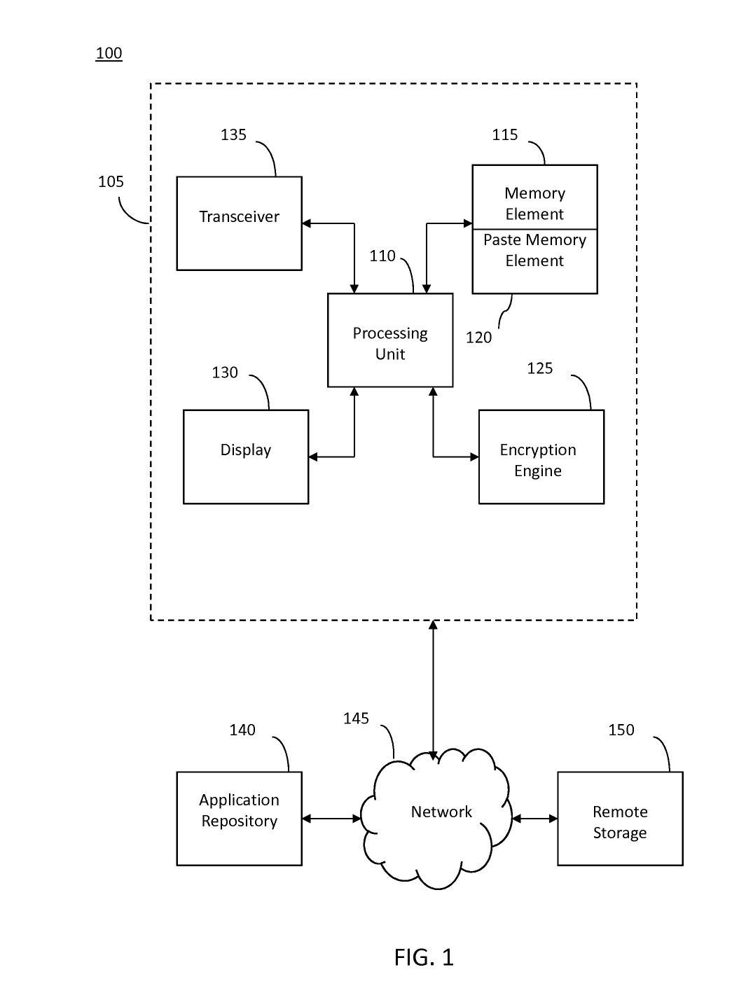

Referring to FIG. 1, an example of system 100 that supports communications among unrelated applications is shown. A computing device 105 may be part of the system 100, and the device 105 may include a processing unit 110, a memory element 115 and a paste memory element 120. In one arrangement, the paste memory element 120 may be part of the memory element 115—although it may also be a separate and distinct unit—and may be communicatively coupled to the processing unit 110. As an example, the paste memory element 120 may be configured to accept and store data from a first application and enable the first application or a second application to retrieve this data. This process is sometimes referred to as a copy-and-paste operation, although it must be understood that the description herein is not limited to the simple temporary storage of text for later pasting. In fact, virtually any type of data may be placed in the paste memory element 120 for later retrieval.

The computing device 105 may also include an encryption engine 125, a display 130 and a transceiver 135, each of which may be communicatively coupled to the processing unit 110. The encryption engine 125 may selectively encrypt data associated with various applications and subsequently decrypt such data on behalf of other applications. Those skilled in the art will appreciate that virtually any type of encryption scheme may be employed here. The display 130 may present any suitable combinations of user interface elements to a user and may also provide a medium for data entry, such as through the use of a touchscreen. In addition, the transceiver 135 can be configured to support virtually any type of communications, including wireless or wired and local or wide area connections. As those skilled in the art will appreciate, multiple transceivers 135 may be part of the computing device 105 to support multiple communication protocols or standards. The computing device 105 may be a wireless device, such as a smartphone, tablet or a laptop, although it may also be a device that is coupled to some hard-wired connection, such as a desktop computer or a server. It is also understood that the computing device 105 may include a suitable operating system and a layered architecture to enable abstractions that allow for the installation of various types of applications and other software and for their interactions with other software components and hardware.

The system 100 may also include an application repository 140, a network 145 and a remote storage unit 150. The network 145, for example, may be comprised of any suitable combination of components to enable any type of wireless or wired communications. In fact, the network 145 may comprise multiple networks, each working in tandem to support communications between the computing device 105 and the application repository 140, the remote storage unit 150 or some other component. In one arrangement, the application repository 140 may be any combination of components that are configured to offer applications for download to the computing device 105. The applications that are offered at the application repository 140 may be developed by or for various parties, thus providing a wide variety of applications to the user of the computing device 105. As will be explained below, the computing device 105 may store data at the remote storage unit 150 for later retrieval.

In one example, the computing device 105 may be a managed device, which enables a party to control certain aspects of the device 105, including the type of content that may be delivered to the device 105. Earlier presentations have been provided that illustrate a solution that describes some of these techniques, such as in U.S. Pat. No. 8,615,581, issued on Dec. 24, 2013, which is incorporated by reference herein in its entirety.

The computing device 105 may present an environment that restricts or substantially restricts communications among unrelated applications. The phrase “restricts communications” is defined as a condition in which the unfettered exchange of data is not available or applications may not have certain permissions for sharing or managing data with respect to another application or service and any communications that are permitted are not done in a secure manner. For example, a first unrelated application may not be able to freely exchange data with a second unrelated application and any exchange that is allowed is open to other unrelated applications. This condition may be based on the construction of the applications themselves, the rules of the environment in which the applications are operating or a combination of both. In such a setting, the paste memory element 120 of the device 105 can be identified and can store a file system. Any suitable structure for the file system may be employed here, and the applications of the device 105 may use the file system to access data from memory elements that have been allocated to them. Through the paste memory element 120, the applications can also share this file system. Thus, a VFS is presented here that can be shared among unrelated applications to enable such applications to access their sandboxed data.

Almost all operating systems provide a volatile memory element that enables a user to copy data and paste it into the memory element for later retrieval. In some of these environments, it is also possible to create custom memory elements for copying and pasting and to configure them as persistent memory elements, meaning that the data stored in them may survive reboots or other interruptions to the operation of the memory element. In one arrangement, as part of the identification of a paste memory element, any number of custom paste memory elements can be created to carry out the solutions presented herein. Moreover, these custom paste memory elements may be configured to be persistent memory elements. It is understood, however, that the memory element(s) used for facilitating data exchange among unrelated applications may be any memory element that is part of the computing device. In particular, such memory element is not limited to being a paste memory element and does not have to be persistent in nature.

Whatever its form may be, the designation, creation and allocation of the paste memory element 120 may be predetermined or dynamic in nature. For example, the requirements for storage may be predetermined, and the paste memory element 120 may be created and configured prior to the exchange of data taking place. In another example, the requirements for storage may not be immediately known, and the paste memory element 120 may be set up after such information is obtained. For example, if it is determined that the amount of space available for storage is insufficient and must be expanded, then steps can be taken to allocate additional memory for the data exchange.

With continuing reference to FIG. 1, the computing device 105 may be configured to download and install a plurality of applications. In one arrangement, the computing device 105 can obtain these applications from the application repository 140, which may be an electronic storefront that specializes in the presentation and delivery of applications, although applications may be received from any other suitable source. The repository 140 may be capable of offering a wide variety of applications, with many of them being generated by or for different entities. As noted earlier, the installed applications may be considered unrelated applications such that they are prevented from freely exchanging data or communicating with one another and any permitted exchanges are not done in a secure manner. This condition may be based on the construction of the applications, the operating environment in which they are installed or both. In addition, as is common with such applications, they may be signed with different certificates, such that a first unrelated application may have a certificate that is signed by a first entity and a second unrelated application may have a different certificate signed by a second entity. In one arrangement, the second entity may not be under the direction or control of the first entity.

References have been made to the file system as being a virtual file system (VFS). In some operating environments, when an application is launched, the application may write the contents of the VFS and the contents of the paste memory element 120 to a non-persistent memory location that is reserved for that application when the application is active. By being active, the application has been launched and is being presented to the user for use or is currently being used by the user (i.e., it is not running in the background). When the application is deactivated, any changes to the data of the paste memory element 120 may be written back to the paste memory element 120 and this data (and the VFS) may be flushed from the memory location associated with the deactivated application. By being deactivated, the application may be closed or at least arranged such that it is not currently presented to the user, like being moved to the background. Thus, applications on the computing device 105 may have access to a file system when an application is active, and this arrangement may provide each of the authorized applications such access without any one of them dominating the use of the file system.

As noted earlier, the system 100 of FIG. 1 may include a remote storage unit 150. In one arrangement, a snapshot may be taken of data associated with an unrelated application 155. Moreover, the computing device 105 can transfer this snapshot of data to the remote storage unit 150 or some other suitable component. Thus, the data associated with any number of unrelated applications 155 may be backed-up remotely and can be retrieved in the event of an issue at the computing device 105 or for some other reason. This data may also be backed up to some component that is part of the computing device 105.

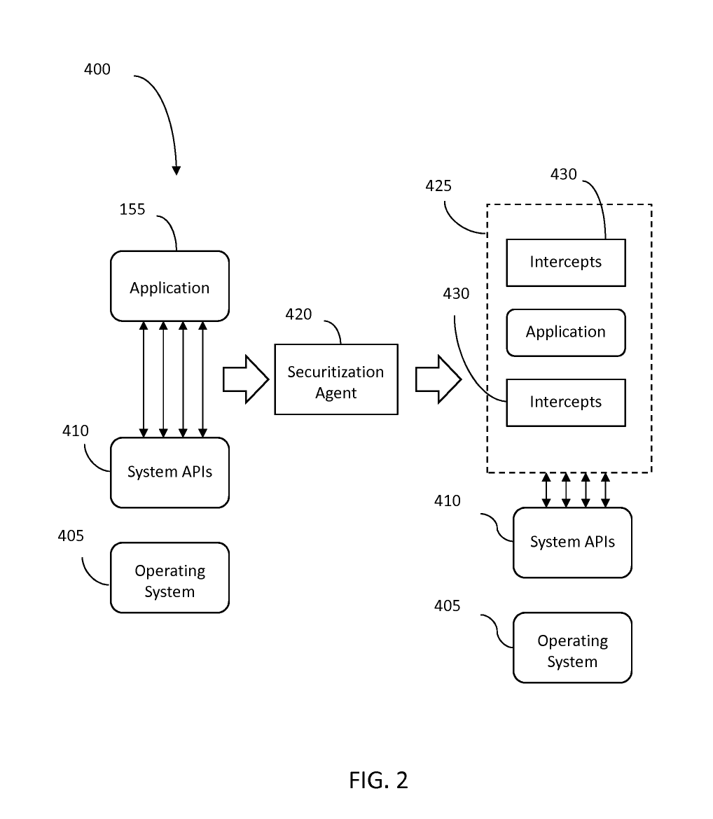

Recent advances have been realized in application configuration and management. In particular, applications may be modified to enable the applications to be managed in a certain way or to achieve new functionalities, a process commonly referred to as wrapping or securitizing an application. Referring to FIG. 2, a representation 400 of the wrapping or securitization process is illustrated. Here, a conventional or target application 155 is shown in which the target application 155 is developed for operating system 405 and calls system APIs 410. At this point, the target application 155 may be considered a non-secure application. The target application 155 can be submitted to a securitization agent 420, and the securitization agent 420 can subject the target application 155 to the wrapping process to generate a secure application 425. The securitization agent 420 can include any suitable number and type of software and hardware elements to carry out the securitization process.

In view of this procedure, the secure application 425 may still maintain its affiliation with the operating system 405 and may still call the system APIs 410. The overall utility of the secure application 425, however, is increased because one or more intercepts 430 may be interposed on the system APIs 410. These intercepts may be representative of any number of policies that are set forth by a party in control of the secure application 425 and of any new or modified functionalities that are realized from the wrapping process.

It is important to note that securitizing an application 155 does not just add a dynamic library to an executable by simply modifying the header of an executable, a process that is easily undone and may violate development agreements associated with the application; rather, it can repackage the application so that the injected code is physically inseparable from the original code. This method prevents secure applications that may be modified by third parties from running within a secure environment.

In addition, the wrapping or securitization process can preserve all the normal functions and APIs of a platform, while ensuring that protected information is handled securely. Application developers do not have to create applications or modify existing applications to accommodate this procedure and are not required to use any custom APIs or lose any functions associated with their applications. Calls to data sharing or data storage APIs may be automatically intercepted to ensure that sensitive enterprise data is handled appropriately. As such, secure applications may share data in the normal methods that are available on a given platform, but secure applications may not be able to share data with non-secure applications.

There are several ways to carry out the process of securing applications. The first scheme primarily focuses on byte-code injection, in which byte-code API calls are replaced with intercepts. As an example, this method is particularly applicable to—but certainly not limited to—certain applications formatted for the Android operating system developed by Google, Inc. of Mountain View, Calif. The second scheme chiefly centers on linking in replacement calls for native object code. This latter method is useful for applications that use native methods, such as Android applications that rely on native code (i.e., they do not run under a virtual machine) and applications developed for iOS, a mobile operating system developed by Apple, Inc. of Cupertino, Calif. Of course, other methods for creating a secure application or ensuring the security of any application may be employed here. Additional information on these concepts is presented in U.S. Pat. No. 8,695,060, issued on Apr. 8, 2014, which is incorporated by reference herein in its entirety.

In view of the wrapping process, the unrelated applications described above may be secure applications. In other words, the unrelated applications may be modified to increase their functionality over their original designs. As one non-limiting example, a first unrelated secure application may be restricted from launching if the computing device 105 is outside a predetermined location or is no longer connected to a certain network. A second unrelated application, as another non-limiting example, may be restricted from launching outside a predetermined time period, such as regular business hours. As can be seen, virtually any type of configuration may be imposed on these secure and unrelated applications.

As may be expected, the configurations of unrelated secure applications may change periodically. The arrangement presented herein, however, enables these unrelated secure applications to access a central location to ensure that their configurations are current. For example, current configuration information for one or more unrelated secure applications may be loaded into the paste memory element 120 using the file system referenced above. At launch or when running in the background, an unrelated secure application may access the paste memory element 120 to ensure that the configuration of the secure application is current. As an example, as part of the configuration for the unrelated secure application, one or more policies may be imposed on the application, such as the geographical or temporal restrictions mentioned above. If the parameters associated with these restrictions are modified, the configuration stored in the paste memory element 120 can be updated, and the application may retrieve this information. As such, the unrelated application can be updated with these new policies. For increased efficiency, the same configurations data may be applicable to multiple unrelated applications, although the description herein is not necessarily limited to this arrangement.

In one embodiment, the unrelated applications may be re-mapped during the wrapping process to interact with and support the file system that is stored in the paste memory element 120. For example, this process may include re-mapping the reading and writing commands of the unrelated application to the file system. The namespace imposed on the paste memory element 120 may also be imposed on the unrelated applications. This procedure can be carried out, for example, when the unrelated applications undergo the wrapping process. The use of secure applications and namespace enforcement can also facilitate the sharing of keys for the encryption/decryption of data described above. That is, these schemes can ensure that only authorized applications may be part of a secure workspace that provides access to a common memory element and a VFS for accessing the element, which presents a much safer environment for sharing keys.

Although unrelated applications that are secure applications may take advantage of the principles presented herein, this description is not so limited. That is, it is important to note that unrelated applications that have not undergone the wrapping process may take advantage of the principles described herein. In addition, the applications (secure or unsecure) that may employ the schemes described herein are not necessarily required to be unrelated applications.

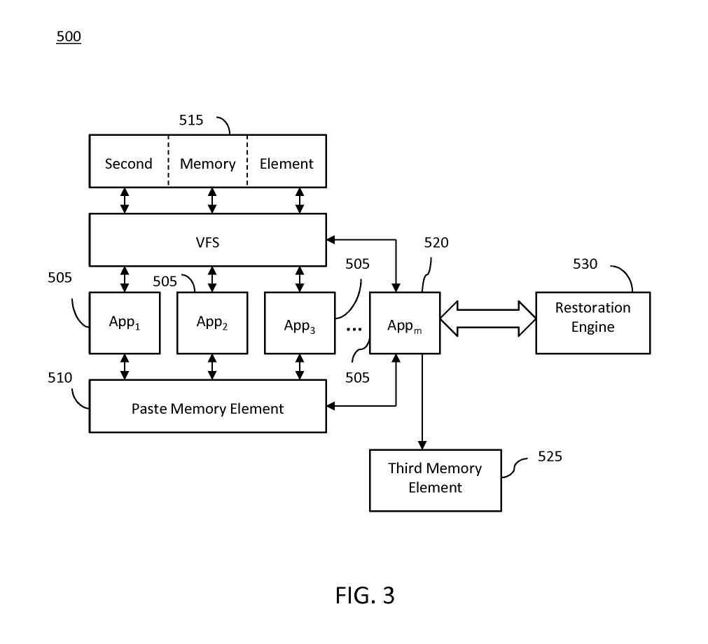

Referring to FIG. 3, an environment 500 in which multiple unrelated applications 505 may share a VFS through a paste memory element 510 is shown. This environment 500 may be part of the computing device 105 introduced in FIG. 1, although the environment 500 may be incorporated into any other suitable device.

As part of the environment 500, a second memory element 515 may be included. The second memory element 515 may be, for example, a non-persistent memory component that is configured to enable the applications 505 to store and access data associated with the applications 505, such as when the applications 505 are active. This data, however, is sandboxed in that the applications 505 are only permitted to access their own data, not that of other applications 505. For example, a first application 505, when active, may retrieve the VFS from the paste memory element 510 and use the VFS to fetch data from its allocation in the second memory element 515. The VFS (and possibly other data from the paste memory element 510) may be stored in the second memory element 515, at least when the first application 505 is active. When the first application 505 is deactivated, the first application 505 may write the VFS (and possibly other data) back to the paste memory element 510. If the first application 505 is made active again, this process may be repeated. Similarly, if a second application 505 is made active, then the second application 505 may retrieve the VFS from the paste memory element 510, store it in the second memory element 515 while active and write the VFS back to the paste memory element 510 when deactivated.

In one arrangement, one of the applications 505 may be a master application 520. In one arrangement, the master application 520 may be solely responsible for backing up and restoring the VFS of the paste memory element 510 among the multiple applications 505. For example, the master application 520 may retrieve the VFS and use the VFS to access its data from its allocated portion of the second memory element 515, similar to that described above. When the master application 520 is deactivated, the master application 520 can write the VFS (and possible other data) back to the paste memory element 510, also similar to that described above.

As part of the procedure when the master application 520 is deactivated, the master application 520 can generate a snapshot of the VFS (and possibly other data from the paste memory element 510) to be stored in its portion of the second memory element 515. In another arrangement, the master application 520 can store the snapshot of the VFS in a third memory element 525, which may be part of the environment 500 or may be a remote storage. As an example, the third memory element 525 may be a persistent memory element. The master application 520 may be moved to the background during this procedure to allow for additional time for its completion without interfering with the opening of other applications 505.

During the time that the master application 520 is deactivated, the VFS may become corrupted or may even be accidentally wiped. When the master application 520 is launched again, the master application 520 may determine that the VFS is inoperable. By inoperable, it is meant that the VFS is in a state in which the VFS is unable to operate properly or in a normal fashion. If the master application 520 makes this determination, the master application 520 may retrieve from the second memory element 515 or the third memory element 525 the snapshot of the VFS. In addition, the master application 520 can then write the back-up image of the VFS to the paste memory element 510. Thus, the VFS and the data can be re-established based on the retrieved snapshot, to be used by the other applications 505.

Some (if not all) of the data from the paste memory element 510 may be encrypted, as noted earlier. When the snapshot of the data is generated and written to the second memory element 515 or third memory element 525, the encrypted data may remain in an encrypted state for the protection of the data and to minimize any inefficiency in the transfer of the data. Of course, if desired, the data may be decrypted prior to being backed-up.

In one arrangement, another application 505 can determine that the VFS is inoperable. For example, a first application 505, when launched, may determine that the VFS has been corrupted or is otherwise unavailable. The first application 505 can then signal the master application 520 (or an intermediary), and the master application 520 can then be launched and can take action to restore the VFS and the data in accordance with the process described above. In a sandboxed environment, any acceptable technique can be used to allow for this interprocess communication, like sending a URL or URI to the master application 520 via the operating system. The first application 505 in this case may be referred to as a non-master application, as it does not control or oversee the restoration of the VFS and data. This ability to cause the master application 520 to launch to perform the restoration procedure may extend to any of the applications 505 of the environment 500. In either case, the back-up and restoration of the VFS can be controlled by a single application, which can ensure the consistency of these elements.

In some instances, the inoperability of the VFS may be intentional. For example, an organization that manages the environment 500 may wish to intentionally erase or delete certain information from the computing device 105. To accommodate such a possibility, the master application 520 may determine whether the removal or corruption of the VFS and/or data from the paste memory element 510 was intentional. If so, the master application 520 may be configured to avoid carrying out the restoration procedure described above.

As an example, the master application 520 may be a personal information manager (PIM) application, which may manage features associated with business and/or social information, like email, contacts, calendar and the browser. In one arrangement, the master application 520 may also be responsible for registering users with a remote server or service or may be responsible for accepting a password or some other authentication information to ensure the authenticity of the user of the environment 500. Of course, any suitable application may serve as the master application 520. In another case, the applications 505 and the master application 520 may be secure or adapted applications, although the description herein is not limited to these types of applications.

The environment 500 may also include a restoration engine 530 that may work with the master application 520 to enable the master application 520 to operate in accordance with the discussion above. To do so, the restoration engine 530 may include any suitable number of components. These components may be hardware and software elements, including, for example, some of the devices illustrated in FIG. 1 and any layers of abstraction that may be implemented to ensure the compatibility of the master application 520.

In some cases, a master application 520 designation may not be necessary. In such an instance, any of the applications 505 may perform the back-up and restoration procedures described above. For example, a first application 505 may be activated and can retrieve the VFS and use it to access its data from its allocation in the second memory element 515. When the first application 505 is deactivated, the first application 505 can generate a snapshot of the VFS, which can be saved in the second memory element 515 or the third memory element 525. When a second application 505 is launched and eventually deactivated, the second application 505 can perform a similar step, generating a snapshot of the VFS and storing it to the second memory element 515 or the third memory element 525.

In addition, if any application 505 detects the inoperability of the VFS, that application 505 can retrieve its snapshot and, working with the restoration engine 530, can restore the VFS, saving its corresponding version of the VFS into the paste memory element 510. That is, any of the applications 505—whether secure or unsecure, unrelated or related—may generate their own snapshots of the VFS and can use such corresponding snapshots to restore the VFS if the VFS is inoperable. Once restored, the VFS can be shared by the other applications 505 via the paste memory element 510. This procedure increases the diversity of the system and removes reliability on a single application for handling such a process.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method for restoring a virtual file system, comprising:
in an environment in which multiple unrelated applications exchange data through a paste memory element, activating a first application from the multiple unrelated applications, wherein the first application is configured to retrieve the virtual file system from the paste memory element and to use the virtual file system to access data associated with the first application;
determining that the virtual file system is inoperable;
retrieving a first snapshot of the virtual file system; and
re-establishing the virtual file system based on the retrieved snapshot.

2. The method according to claim 1, wherein determining that the virtual file system is inoperable, retrieving the first snapshot of the virtual file system and re-establishing the virtual file system based on the retrieved first snapshot are performed via the first application.

3. The method according to claim 2, further comprising activating a second application from the multiple unrelated applications, wherein the second application is configured to retrieve the virtual file system from the paste memory element and to use the virtual file system to access data associated with the second application.

4. The method according to claim 3, further comprising, via the second application:
determining that the virtual file system is inoperable;
retrieving a second snapshot of the virtual file system; and
re-establishing the virtual file system based on the retrieved second snapshot.

5. The method according to claim 2, wherein retrieving the first snapshot of the virtual file system comprises retrieving the first snapshot of the virtual file system from a memory element associated with the first application.

6. The method according to claim 4, wherein retrieving the second snapshot of the virtual file system comprises retrieving the second snapshot of the virtual file system from a memory element associated with the second application.

7. The method according to claim 1, wherein the unrelated applications are secure applications.

8. A method for restoring a virtual file system, comprising:
in an environment in which multiple unrelated applications exchange data through a paste memory element through the use of the virtual file system, using a master application of the multiple unrelated applications, wherein the master application is solely responsible for backing up the virtual file system;
when the master application is deactivated, generating a snapshot of the virtual file system;
storing the snapshot of the virtual file system in a memory location that is associated with the master application;
determining whether the virtual file system is inoperable;
if it is determined that the virtual file system is inoperable, retrieving the snapshot of the virtual file system from the memory location; and
re-establishing the virtual file system based on the retrieved snapshot.

9. The method according to claim 8, wherein the master application is solely responsible for re-establishing the virtual file system based on the retrieved snapshot.

10. The method according to claim 8, further comprising:
launching a non-master application that is part of the multiple unrelated applications, wherein the master application is currently deactivated;
based on the launching of the non-master application, determining that the virtual file system is inoperable;
if it is determined that the virtual file system is inoperable, automatically launching the master application to retrieve the snapshot of the virtual file system from the memory location that is associated with the master application.

11. The method according to claim 8, wherein the multiple unrelated applications are secure applications and the master application is a personal information manager application.

12. A computing device for backing up a virtual file system, comprising:
a paste memory element, wherein the paste memory element is configured to store a virtual file system, wherein the virtual file system enables a first application to access data associated with the first application;
a memory element associated with the first application, wherein the first application is part of a set of multiple unrelated applications; and
a restoration engine that is configured to operate through the first application to:
generate a first snapshot of the virtual file system when the first application is deactivated;
transfer the first snapshot to the memory element associated with the first application;
determine whether the virtual file system is inoperable when the first application is launched; and
if the virtual file system is inoperable, retrieve the first snapshot of the virtual file system from the memory element associated with the first application to enable the virtual file system to be restored.

13. The computing device according to claim 12, wherein the paste memory element is configured to enable the first application to share the virtual file system with any of the other unrelated applications.

14. The computing device according to claim 12, further comprising a second memory element associated with a second application and wherein the virtual file system enables the second application of the set of unrelated applications to access data associated with the second application from the second memory element.

15. The computing device according to claim 14, wherein the restoration engine is further configured to operate through the second application to:
generate a second snapshot of the virtual file system when the second application is deactivated;
transfer the second snapshot to the memory element associated with the second application;
determine whether the virtual file system is inoperable when the second application is launched; and
if the virtual file system is inoperable, retrieve the second snapshot of the virtual file system from the memory element associated with the second application to enable the virtual file system to be restored.

16. The computing device according to claim 15, wherein the restoration engine is further configured to operate through any of the unrelated applications to generate snapshots of the virtual file system and retrieve such snapshots to enable the virtual file system to be restored by any of the unrelated applications.

17. The computing device according to claim 12, wherein the set of unrelated applications are secure applications.

18. A computing device for backing up a virtual file system, comprising:
a paste memory element, wherein the paste memory element is configured to store a virtual file system that is configured to enable multiple unrelated applications to access their corresponding data;
a memory element associated with a master application, wherein the master application is part of the multiple unrelated applications and is solely responsible among the unrelated applications for backing up the virtual file system; and
a restoration engine that is configured to operate through the master application to:
generate a snapshot of the virtual file system when the master application is deactivated;
transfer the snapshot to the memory element associated with the master application;
determine whether the virtual file system is inoperable when the master application is launched; and
if the virtual file system is inoperable, retrieve the snapshot of the virtual file system from the memory element to enable the virtual file system to be restored.

19. The computing system according to claim 18, wherein the unrelated applications are secure applications and the master application is a personal information manager application.

20. The computing system according to claim 18, wherein the master application is also solely responsible for retrieving the snapshot of the virtual file system if it is determined that the virtual file system is inoperable.
